(19) United States
(12) Patent Application Publication
(10) Pub. No.: US 2019/0126529 A1
(43) Pub. Date: May 2, 2019

(54) DEVICE FOR ENSHEATHING A CONDUCTOR

(71) Applicant: Rosendahl Nextrom GmbH, Pischelsdorf am Kulm (AT)

(72) Inventor: Werner HOERSCHLAEGER, Pirka (AT)

(21) Appl. No.: 16/175,003

(22) Filed: Oct. 30, 2018

(30) Foreign Application Priority Data
Oct. 30, 2017 (AT) A 50906/2017

(51) Int. Cl. B29C 47/92; B29C 47/00; B29C 47/02; B29C 47/88

(52) U.S. Cl. CPC B29C 47/92; B29C 47/0014; B29C 47/025; B29L 2011/0075; B29C 2947/92704; B29C 2947/926; B29C 47/8815

(57) ABSTRACT

A device for ensheathing at least one conductor in a sheath that consists of plastic has an extruder, a first cooling system arranged behind the extruder, a first conveying system behind the first cooling system, and another conveying system for fixing the length of the sheath relative to the conductor. The first conveying system has two units for controlling the conveying speed of the sheath, which can be driven at different conveying speeds.

### BACKGROUND OF THE INVENTION

### Field of the Invention

The invention relates to a device for ensheathing at least one conductor in a sheath that consists of plastic, with an extruder, a first cooling system arranged behind the extruder, a first conveying system behind the first cooling system, and another conveying system for fixing the length of the sheath relative to the conductor.

### Description of the Related Art

Such a device is known from, for example, U.S. Pat. No. 8,489,219 B1. The problem with such devices, in particular when they are devices for ensheathing optical waveguides, lies in the fact that the conductor is to be accommodated in the sheath with a relatively exact excess length, whereby the sheath that is extruded around the conductor has a shrinkage behavior during solidification or cooling that impedes precise setting of the excess length.

### SUMMARY OF THE INVENTION

The object of the invention is therefore to provide a device of the above-mentioned type, in which an excess length of the conductor can be set as precisely as possible or the shrinkage behavior of the sheath can be controlled as exactly as possible.

This object is achieved with a device that has the features of claim 1.

According to the invention, the first conveying system has two means for controlling the conveying speed of the sheath, which can be driven at different conveying speeds.

After the sheath of the conductor behind the extruder has been cooled by a first cooling system arranged behind the extruder to the point where it has only a small plastic deformability, it is fed to another conveying system to fix the length thereof relative to the conductor, conveyed by the first conveying system, which has two means for controlling the conveying speed of the sheath. On the one hand, the speed at which the sheathed conductor is removed by the first means from the above system, and, on the other hand, the speed at which the sheathed conductor is further conveyed by the second means to the following system can be set individually by these two means that can be driven at different speeds. In addition, if necessary, a certain amount of stretching or compression of the sheath can thus also be produced between the two means, so that viewed overall, a targeted setting of the shrinkage behavior of the sheath relative to the desired excess length of the conductor is possible.

When a conductor is mentioned in the description above and below, this is a generic term both for an individual conductor and for multiple conductors, conductor bundles or arrangements that consist of conductors or conductor bundles that are already sheathed. In addition, all types of conductors, in particular optical waveguides, but also galvanic conductors, fall under the term conductor, although in the last-mentioned conductors, the above-discussed problem occurs to a reduced extent.

The means for controlling the conveying speed can be selected or combined arbitrarily. For example, it is possible that a means or both means is or are a belt pull-off, between whose belts the sheathed conductor is conveyed by friction.

It is equally possible and preferred in the case of the invention, however, when at least one means, preferably both means, has or have two disks for controlling the conveying speed, between which the sheathed conductor is conveyed by friction, since a compact and very effective type of construction is thus possible.

When the means for controlling the conveying speed has or have disks, one embodiment according to the invention is especially preferred in which at least one of the disks has a V-shaped groove on its periphery. This embodiment is preferred, although combining with a disk that has a flat periphery is not mandatory. The disk with the flat or non-profiled periphery then presses the sheathed conductor into the groove of the other disk, in which it is very easily held by friction because of the V-shaped configuration of the groove.

When, in another preferred embodiment of the invention, the distance between the means for controlling the conveying speed can be set, this makes it possible to take into account the cooling behavior or the plastic behavior of the plastic that is selected in each case for the ensheathing at specific temperatures or with specific wall thicknesses of the sheath, since the dwell time of the sheathed conductor between the two means can be controlled, without changing the conveying speed.

This is particularly advantageous if another cooling system is arranged between the means for controlling the conveying speed or if the means for controlling the conveying speed are arranged in a cooling system.

### BRIEF DESCRIPTION OF THE DRAWINGS

Additional features and advantages of the invention will follow from the description below of a preferred embodiment of the invention that does not limit the scope of protection with reference to the attached drawings. Here:

FIG. 1 shows an embodiment of a device according to the invention for ensheathing at least one conductor in a sheath that consists of plastic, and

FIG. 2 shows a preferred embodiment of a means for controlling the conveying speed of the sheath.

### DESCRIPTION OF THE PREFERRED EMBODIMENTS

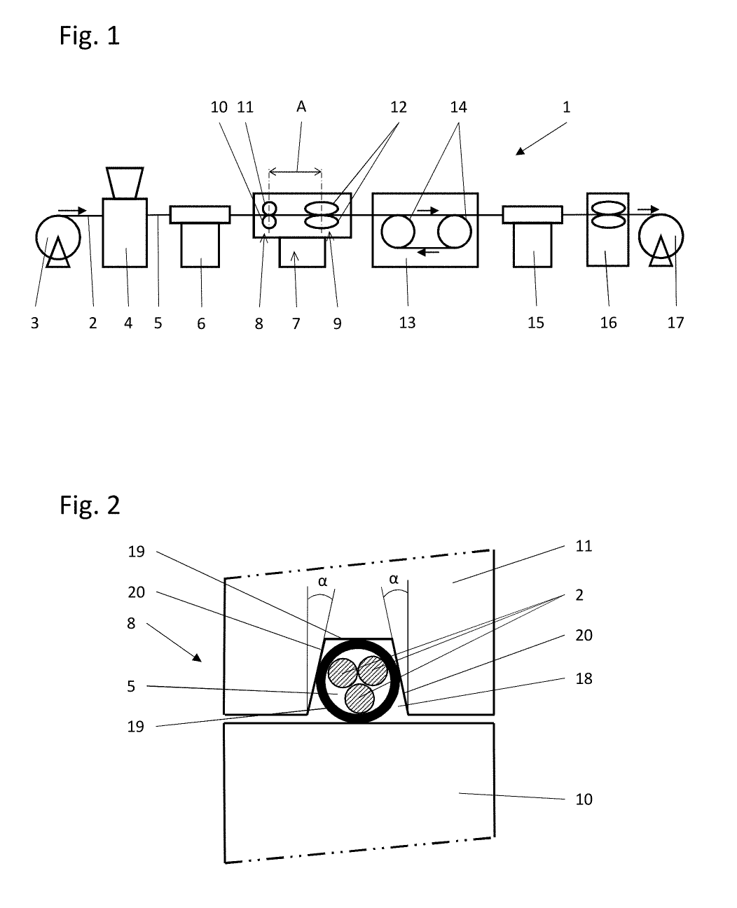

FIG. 1 depicts an embodiment of a device according to the invention, which, however, is only by way of example and can also be embodied differently, aside from the features according to the invention as defined in the claims, within the scope of this invention relative to many components, without this requiring a special mention below.

In the depicted embodiment, a conductor 2 is removed from a spool 3 and is provided in an extruder 4 with a sheath 21 that consists of plastic. It is understood that the conductor 2 does not have to be removed from a spool 3, but rather it can also come from a different system, for example a spinning system, in which two or more conductors 2 have been spun with one another with an alternating lay direction. Also, more than one spool 3 can be provided, from which two or more conductors 2 or conductor bundles are removed and fed to the extruder 4.

Also, it is possible that in front of the extruder 4, a gel, powder or other lubricant, separating agent or the like, which is suitable or is required for the respective design and intended use of the cable that is to be produced, is applied on the conductor 2.

Behind the extruder 4, the sheathed conductor 5 enters into a first cooling system 6, in which the sheath 21 is cooled to a temperature at which it already has a certain amount of strength and dimensional stability.

The first conveying system 7, essential to the invention, is arranged behind the first cooling system 6, which conveying system 7 has a first means 8 and a second means 9, with which the conveying speed of the sheath 21 can be controlled or regulated with the conductor 2 arranged therein.

Each means 8, 9 has a separate drive, with which the peripheral speed or conveying speed of the respective means 8, 9 can be set independently of the peripheral speed or conveying speed of the other means 8, 9 in each case. In the embodiment depicted in FIG. 1, a combination that consists of a first means 8 with two disks 10, 11 and a second means 9 with a belt pull-off with two circumferential belts 12 is depicted. In the case of the invention, however, it is preferred, but not mandatory, that the first means 8 and the second means 9 have essentially the same design.

Between the two means 8, 9, a cooling system can be arranged, with which the cooling speed of the sheath 21 can be controlled. Also, it is possible that the first conveying system 7 has, for example, a dipping basin, into which the two means 8, 9 are dipped with the sheathed conductor 5 guided in between them.

It is understood that the conveying system 7 that is referred to as the “first” conveying system does not actually have to be the first conveying system, but rather it is also possible within the scope of the invention that one or more other conveying systems are arranged in front of the conveying system 7. Also, the first cooling system 6 does not have to be the only cooling system, but rather there can also be provided multiple cooling systems, optionally with conveying systems arranged in between.

The distance A between the two means 8, 9 can be set in an especially preferred, but not mandatory, embodiment of the invention. Thus, on the one hand, the cycle time of the sheathed conductor 5 between the two means 8, 9 and thus its cooling in between can be influenced. On the other hand, the degree to how far the sheath 21 can be stretched or compressed between the two means 8, 9 can also be influenced when the means 8, 9 are operated at different conveying speeds. Thus, in the case of a specific speed difference between the two means 8, 9, a larger distance A leads to a smaller stretching or compression than a smaller distance A.

Another conveying system 13, in which the sheath 21 is cooled or tempered so that it essentially has no plastic deformability, but rather only an elastic deformability, with which the excess length of the conductor 2 is largely fixed compared to its sheath 21, is arranged behind the conveying system 7. Preferably, although not necessarily, a so-called disk pull-off is used as another conveying system 13, in which disk pull-off the sheathed conductor 5 is run around two pull-off disks 14 at least once and preferably multiple times, and in this case is cooled to the desired or necessary temperature.

In this case, in particular the conveying speed of the second means 9 in relation to the conveying speed of the additional conveying system 13 can be relevant, since the excess length of the conductor 2 thus can be set relative to the sheath 21 before the sheath 21 is cooled in the additional conveying system 13 so that it no longer has any plastic deformability.

The control of the conveying speed of the additional conveying system 13 and the first conveying system 7, in particular of the means 9, can preferably, but of course not necessarily, be carried out in such a way that the conveying system 13 presets the conveying speed and thus is the “master,” and the first conveying system 7 in relation thereto is controlled and thus is the “slave.”

Additional systems that are not important for this invention, known in the art and essentially matched to the cable that is to be produced, for example another cooling system 15 and a belt pull-off 16, can be arranged behind the additional conveying system 13, before the sheathed conductor 5 or the cable that is thus produced is coiled, for example, onto a spool 17.

FIG. 2 depicts a preferred embodiment of the means 8, 9 for controlling the conveying speed of the sheath 21 or the sheathed conductor 5 in the form of disks 10, 11. Of the disks 10, 11, the only areas depicted are those in which they are directly opposite one another and clamp or hold by friction or by force the sheathed conductor 5 between them.

In the depicted embodiment, the upper disk 11 has a groove 18 that widens in a V shape with a flat base 19 and side walls or flanks 20. The flank angles α lie in, for example, an area between 1° and 10°, preferably approximately 5°. The lower disk 10 has a flat, i.e., non-profiled, periphery and presses the sheathed conductor 5 into the V-shaped groove 18.

FIG. 2 diagrammatically depicts a sheathed conductor 5, which has, for example, three conductors 2, which are accommodated in a sheath 21 that was extruded by the extruder 4 around the three conductors 2. The dimension of the groove 18, i.e., its width, depth and flank angle α, is matched to the diameter and the design of the sheathed conductor 5 or to the material of the sheath 21, so that the sheathed conductor 5 is pressed by the disk 10 firmly into the groove 18, so that, on the one hand, the static friction between the sheath 21 and the inside surfaces of the groove 18 is large enough that it does not result in an unreliable, major slip, but, on the other hand, damage to the sheath 21 and the conductor 2 accommodated therein is reliably avoided.

The material of the disks 10, 11 is preferably steel, whereby it is also possible, however, that one and/or both disks 10, 11 consist of another material or are coated with another material.
1 Device
2 Conductor
3 Spool
4 Extruder
5 Sheathed conductor
6 First cooling system
7 First conveying system
8 First means
9 Second means
10 Disk
11 Disk
12 Belts
13 Additional conveying system
14 Pull-off disks
15 Additional cooling system
16 Belt pull-off
17 Spool
18 Groove
19 Base
20 Side walls or flanks
21 Sheath

1. Device for ensheathing at least one conductor (2) in a sheath (21) that consists of plastic, with an extruder (4), a first cooling system (6) arranged behind the extruder (4), a first conveying system (7) behind the first cooling system (6), and another conveying system (13) for fixing the length of the sheath (21) relative to the conductor (2), wherein the first conveying system (7) has two means (8, 9) for controlling the conveying speed of the sheath (21), which can be driven at different conveying speeds.

2. Device according to claim 1, wherein at least one means (9) for controlling the conveying speed is a belt pull-off, between whose belts (12) the sheathed conductor (5) is conveyed by friction.

3. Device according to claim 1, wherein at least one means (8) for controlling the conveying speed has two disks (10, 11), between which the sheathed conductor (5) is conveyed by friction.

4. Device according to claim 3, wherein at least one of the disks (11) has a V-shaped groove (18) on its periphery.

5. Device according to claim 4, wherein a flank angle (α) of the groove lies between 1° and 10°.

6. Device according to claim 4, wherein a disk (10) has a flat periphery.

7. Device according to claim 1, wherein the distance (A) between the means (8, 9) can be set to control the conveying speed.

8. Device according to claim 1, wherein another cooling system is arranged between the means (8, 9) for controlling the conveying speed or wherein the means (8, 9) for controlling the conveying speed are arranged in a cooling system.

9. Device according to claim 1, wherein the additional conveying system (13) has a cooling system or is arranged in a cooling system.

10. Device according to claim 1, wherein the additional conveying system (13) has a disk pull-off.

11. Device according to claim 2, wherein at least one means (8) for controlling the conveying speed has two disks (10, 11), between which the sheathed conductor (5) is conveyed by friction.

12. Device according to claim 5, wherein a disk (10) has a flat periphery.

13. Device according to claim 2, wherein the distance (A) between the means (8, 9) can be set to control the conveying speed.

14. Device according to claim 3, wherein the distance (A) between the means (8, 9) can be set to control the conveying speed.

15. Device according to claim 4, wherein the distance (A) between the means (8, 9) can be set to control the conveying speed.

16. Device according to claim 5, wherein the distance (A) between the means (8, 9) can be set to control the conveying speed.

17. Device according to claim 6, wherein the distance (A) between the means (8, 9) can be set to control the conveying speed.

18. Device according to claim 2, wherein another cooling system is arranged between the means (8, 9) for controlling the conveying speed or wherein the means (8, 9) for controlling the conveying speed are arranged in a cooling system.

19. Device according to claim 3, wherein another cooling system is arranged between the means (8, 9) for controlling the conveying speed or wherein the means (8, 9) for controlling the conveying speed are arranged in a cooling system.

20. Device according to claim 4, wherein another cooling system is arranged between the means (8, 9) for controlling the conveying speed or wherein the means (8, 9) for controlling the conveying speed are arranged in a cooling system.
